(19) United States
(12) Patent Application Publication
(10) Pub. No.: US 2024/0332880 A1
(43) Pub. Date: Oct. 3, 2024

(54) MANUFACTURING METHOD FOR UNIPOLAR TERMINAL BLOCK

(71) Applicant: Yazaki Corporation, Tokyo (JP)

(72) Inventors: Hiroaki ONO, Makinohara-shi (JP); Toru SUZUKI, Makinohara-shi (JP)

(73) Assignee: Yazaki Corporation, Tokyo (JP)

(21) Appl. No.: 18/597,380

(22) Filed: Mar. 6, 2024

(30) Foreign Application Priority Data
Mar. 27, 2023 (JP) 2023-049258

(51) Int. Cl. H01R 43/24; H01R 9/24

(52) U.S. Cl. CPC H01R 43/24; H01R 9/24

(57) ABSTRACT

A manufacturing method for a unipolar terminal block, wherein the unipolar terminal block comprises a terminal including a first connection portion formed on one end side and a second connection portion formed on the other end side, and a resin portion holding the terminal, includes setting a metal rod material before the first connection portion or the second connection portion is formed into a cavity of a mold unit for molding the resin portion and filling molten resin into the cavity to mold the resin portion; and after the resin portion is molded, processing the rod material to mold the first connection portion or the second connection portion.

### TECHNICAL FIELD

The present invention relates to a terminal block.

### BACKGROUND ART

There are various structures included in terminal blocks for wiring connections, and an example thereof is shown in FIG. 7 (see Patent Document 1). A terminal block 500 shown in FIG. 7 is fixed to a housing of a travel motor mounted on a vehicle, and includes three busbars 502, two collars 503, and a housing 504 holding these configurations.

Each busbar 502 includes a first connection portion 521 and a second connection portion 522. The first connection portion 521, for example, is connected to a terminal of a motor for travelling. The second connection portion 522, for example, is connected to a terminal of an inverter.

The collar 503 is made of metal and has a cylindrical shape. A bolt for fixing the terminal block 500 to a housing of the motor for travelling is passed through the collar 503.

The housing 504 is made of insulating synthetic resin. The housing 504 is formed by filling a mold cavity with molten resin and solidifying the molten resin. Also, the busbar 502 and the collar 503 are set in the mold cavity when the housing 504 is molded, and are insert-molded into the housing 504.

In addition to the terminal block 500 described above, there are terminal blocks of various shapes to match the mounting conditions of each vehicle.

### CITATION LIST

### Patent Documents

[Patent Document 1] JP 2022-52013A

### SUMMARY OF THE INVENTION

### Technical Problem

With regard to manufacturing the terminal blocks of various shapes described above, it is necessary to construct a mold for each product, which leads to a problem of increasing development time and cost.

Therefore, an object of the present invention is to provide a technique for manufacturing various types of unipolar terminal blocks by sharing a mold.

### Solution to Problem

According to the present invention, a manufacturing method for a unipolar terminal block, wherein the unipolar terminal block comprises a terminal including a first connection portion formed on one end side and a second connection portion formed on the other end side, and a resin portion holding the terminal, includes setting a metal rod material before the first connection portion or the second connection portion is formed into a cavity of a mold unit for molding the resin portion and filling molten resin into the cavity to mold the resin portion; and after the resin portion is molded, processing the rod material to mold the first connection portion or the second connection portion.

### Effect of the Invention

According to the present invention, various types of unipolar terminal blocks can be manufactured by sharing a mold.

### BRIEF DESCRIPTION OF THE DRAWINGS

FIG. 1 is a perspective view showing an example of a unipolar terminal block that is manufactured by a manufacturing method according to an embodiment of the present invention.

FIG. 2 is a perspective view showing the unipolar terminal block in FIG. 1 from another angle.

FIG. 3 is a perspective view showing another example of the unipolar terminal block manufactured by the manufacturing method according to the embodiment of the present invention.

FIG. 4 is a perspective view showing further another example of the unipolar terminal block manufactured by the manufacturing method according to the embodiment of the present invention.

FIG. 5 is a perspective view showing a semi-finished product during the manufacturing of the unipolar terminal block in FIG. 1 to FIG. 4.

FIG. 6A is a rear view showing a terminal block assembling structure in which the unipolar terminal block manufactured by the manufacturing method according to the embodiment of the present invention is attached to an attached portion.

FIG. 6B is a planar view showing a terminal block assembling structure in which the unipolar terminal block manufactured by the manufacturing method according to the embodiment of the present invention is attached to the attached portion.

FIG. 7A is a rear view showing another terminal block assembling structure in which the unipolar terminal block manufactured by the manufacturing method according to the embodiment of the present invention is attached to the attached portion.

FIG. 7B is a planar view showing another terminal block assembling structure in which the unipolar terminal block manufactured by the manufacturing method according to the embodiment of the present invention is attached to the attached portion.

FIG. 8 is a perspective view showing a conventional terminal block.

### DESCRIPTION OF EMBODIMENTS

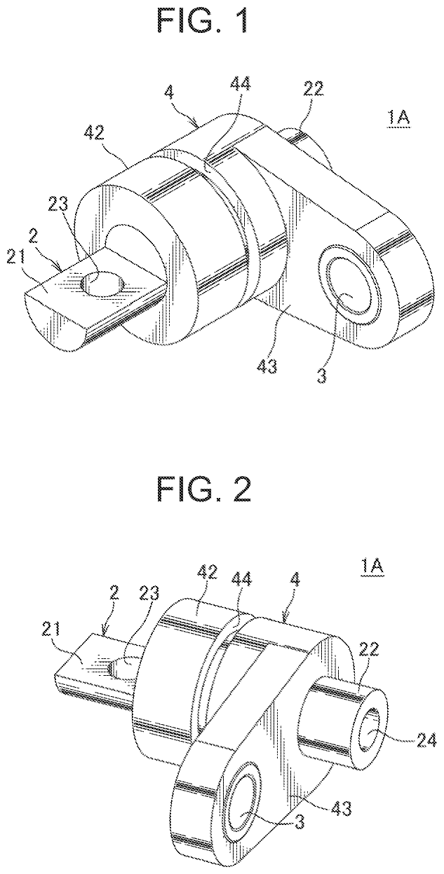

A “manufacturing method for a unipolar terminal block” according to an embodiment of the present invention will be described with reference to FIG. 1 to FIG. 5.

A unipolar terminal block 1A shown in FIG. 1 and FIG. 2 is a component for connecting wires to each other. This unipolar terminal block 1A includes a unipolar terminal 2 in which a first connection portion 21 is formed on one end side and a second connection portion 22 is formed on the other end side, a collar 3, and a resin portion 4 to hold the terminal 2 and the collar 3.

The first connection portion 21 is formed in a semi-cylindrical shape as a shape obtained by dividing a cylinder into two along a plane passing through a central axis thereof, and includes a bolt insertion hole 23.

The second connection portion 22 is formed in a cylindrical shape and includes a female threaded portion 24. The female threaded portion 24 includes a hole formed concavely from the other end of the terminal 2, and a screw cut spirally on the inner circumferential surface of the hole.

The collar 3 is made of metal and has a cylindrical shape. A bolt for fixing the unipolar terminal block 1A to an attached portion is passed through the collar 3.

The resin portion 4 is configured by being molded by a mold unit while being made of an insulating synthetic resin, and includes a cylindrical terminal holding portion 42 and a plate-shaped collar holding portion 43 continuous to the outer circumferential surface of the terminal holding portion 42. An annular packing attachment groove 44 for attaching an annular packing is formed on the outer circumferential surface of the terminal holding portion 42.

The terminal 2 is insert-molded in the resin portion 4, wherein the first connection portion 21 protrudes from one end surface of the terminal holding portion 42, the second connection portion 22 protrude from the other end surface of the terminal holding portion 42, and the central portion is embedded in the terminal holding portion 42.

The collar 3 is insert-molded into the resin portion 4. The outer circumferential surface of the collar 3 is covered with a collar holding portion 43. The central axis of the collar 3 is parallel to the central axis of the second connection portion 22.

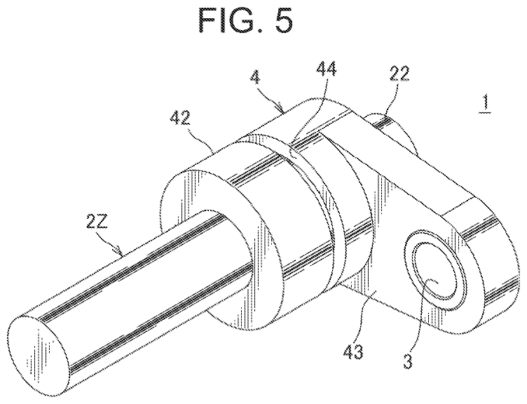

The unipolar terminal block 1A is manufactured by the following method. At first, in the cavity of the mold unit for molding the resin portion 4, only the second connection portion 22 is formed, and a metal rod material in which the first connection portion 21 is not formed and the collar 3 is set therein. Next, the cavity is filled with the molten resin to mold the resin portion 4, then the mold is opened to take out the molded product shown in FIG. 5, that is, a semi-finished product 1. The reference sign 2Z refers to a metal rod material in which only the second connection portion 22 is formed and the first connection portion 21 has not been formed. Then, the rod material 2Z of the semi-finished product 1 is subjected to a cutting process (one end side of the rod material 2Z is cut into a semi-cylindrical shape to form the bolt insertion hole 23) to form the first connection portion 21. The unipolar terminal block 1A is manufactured by such procedures.

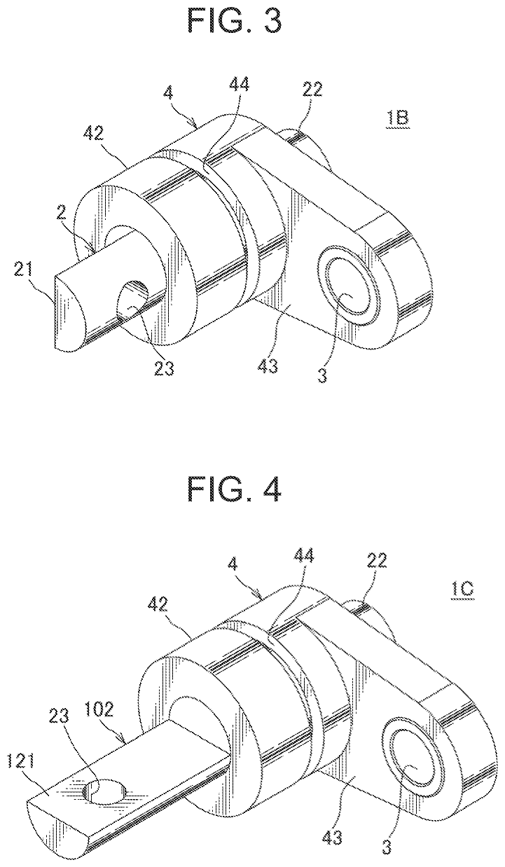

In the manufacturing process described above, by changing the contents of the cutting process applied to the rod material 2Z of the semi-finished product 1, it is possible to manufacture a unipolar terminal block 1B shown in FIG. 3, a unipolar terminal block 1C shown in FIG. 4, and the like.

The unipolar terminal block 1B is different from the unipolar terminal block 1A in the orientation of the first connection portion 21 with respect to the collar 3, that is, the orientation of the bolt insertion hole 23, and other configurations are the same with the unipolar terminal block 1A.

The terminal 102 of the unipolar terminal block 1C includes a first connection portion 121 that is longer than the first connection portion 21 of the terminal 2 of the unipolar terminal block 1A. That is, the unipolar terminal block 1C is different from the unipolar terminal block 1A in the position of the bolt insertion hole 23, and other configurations are the same with the unipolar terminal block 1A.

In this manner, according to the present example, various types of unipolar terminal blocks 1A, 1B, and 1C can be manufactured by sharing the common mold unit.

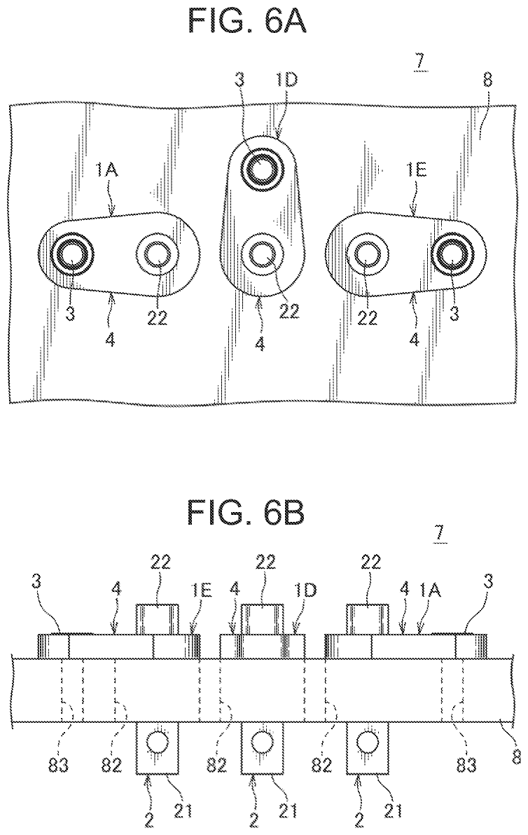

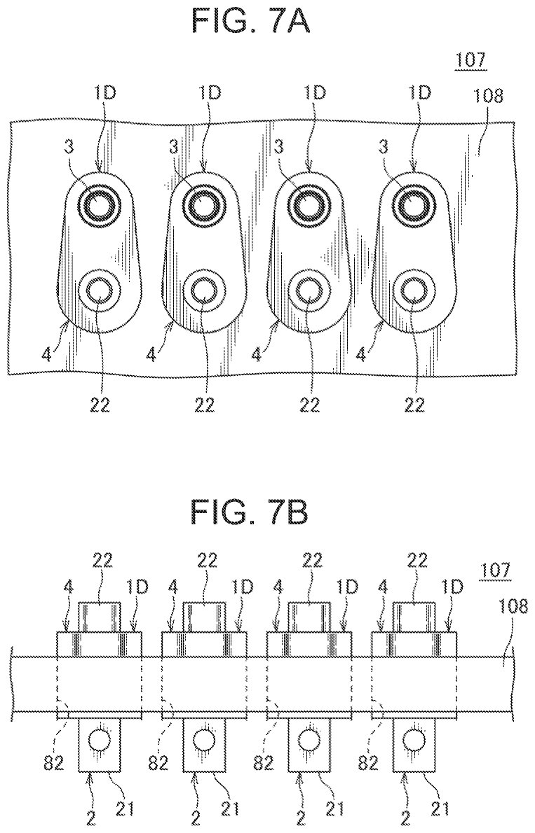

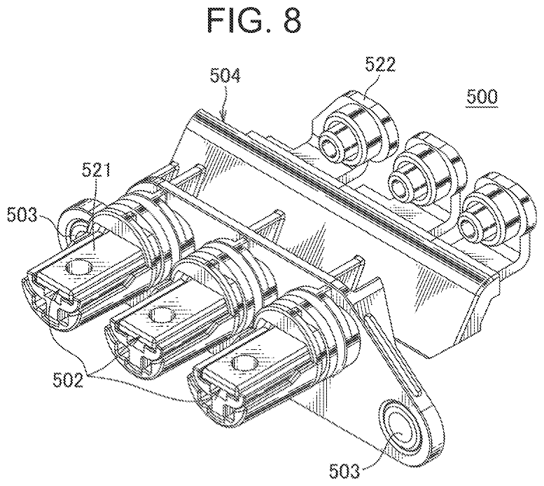

The unipolar terminal block obtained by the above-described manufacturing method is attached to an attached portion, for example, as shown in FIG. 6A to FIG. 7B.

The terminal block assembly structure 7 shown in FIG. 6A and FIG. 6B is configured to have three unipolar terminal blocks 1A, 1D, 1E having mutually different specifications that are attached to the attached portion 8. The unipolar terminal blocks 1A, 1D, 1E use the same collar 3, wherein the orientations of the bolt insertion holes 23 thereof with respect to the collar 3 are different from each other, and other configurations are the same. All of these are manufactured using a common mold.

The attached portion 8 is a casing of an inverter mounted on a vehicle. In the attached portion 8, three insertion holes 82 through which the terminal holding portions 42 of the unipolar terminal blocks 1A, 1D, 1E are inserted respectively, and three bolt insertion holes 83 through which the bolts inserting through the collars 3 of the unipolar terminal blocks 1A, 1D, 1E are inserted respectively are formed.

Each unipolar terminal block 1A, 1D, 1E is inserted into each insertion hole 82, the bolt is inserted into each collar 3 and each bolt insertion hole 83, and a nut is screwed to the bolt such that each unipolar terminal block 1A, 1D, 1E is fixed to the attached portion 8. Further, the gap between the insertion hole 82 and the terminal holding portion 42 is sealed by the packing attached to the packing attachment groove 44 of each of the unipolar terminal blocks 1A, 1D, 1E.

As shown in FIG. 6B, the first connection portions 21 of the unipolar terminal blocks 1A, 1D, 1E are positioned on one side of the attached portion 8, that is, on the inner side of the casing. These first connection portions 21 are overlapped by terminals of the inverter, and then fastened together by the bolts inserted through the bolt insertion holes 23 and the nuts screwed to the bolts.

As shown in FIG. 6B, the second connection portions 22 of the unipolar terminal blocks 1A, 1D, 1E are positioned on the other side of the attached portion 8, that is, on the outer side of the casing. These second connection portions 22 are overlapped with the round terminals connected to the ends of the electric wires, and then are fastened together with the round terminals by the bolts screwed into the female screw portions 24.

Since such terminal block assembling structure 7 uses the unconnected unipolar terminal blocks 1A, 1D, 1E, it is possible to flexibly respond to changes of the positions of the bolt insertion holes 83 in the attached portion 8, changes of the pitch between the terminals 2, changes of the number of poles of the terminals 2, and the like.

The terminal block assembling structure 107 shown in FIGS. 7A and 7B is configured that four unipolar terminal blocks 1D having the same configuration are attached to the attached portion 108. Similar to the terminal block assembling structure 7, this terminal block assembling structure 107 uses the unconnected unipolar terminal blocks 1D such that it is possible to change the position of the bolt insertion hole in the attached portion 108 or to It is possible to flexibly respond to changes of the positions of the bolt insertion holes in the attached portion 8, changes of the pitch between the terminals 2, changes of the number of poles of the terminals 2, and the like.

In the above-described embodiment, the metal rod material 2Z in which only the second connection portion 22 is formed and the first connection portion 21 has not yet been formed is set in the cavity of the mold unit for molding the resin portion 4. In addition to this, in the present invention, a metal rod material in which only the first connection portion is formed and the second connection portion has not yet been formed may be insert-molded in the resin portion, and the second connection portion may be formed after the resin portion is molded. Alternatively, a metal rod material in which the first connection portion and the second connection portion have not yet been formed may be insert-molded into the resin portion, and the first connection portion and second connection portion may be formed after the resin portion is molded.

Also, the above-described embodiment merely shows a typical embodiment of the present invention, and the present invention is not limited to this embodiment. That is, various modifications can be made without departing from the spirit of the present invention. Once the configurations according to the present embodiment are included, even if such modifications are applied, the configurations should be included within the scope of the present invention.

### REFERENCE SIGNS LIST

1A, 1B, 1C, 1D, 1E unipolar terminal block
2, 102 terminal
3 collar
4 resin portion
21, 121 first connection portion
22 second connection portion

What is claimed is:

1. A manufacturing method for a unipolar terminal block, wherein the unipolar terminal block comprises a terminal including a first connection portion formed on one end side and a second connection portion formed on the other end side, and a resin portion holding the terminal, the method comprising:
setting a metal rod material before the first connection portion or the second connection portion is formed into a cavity of a mold unit for molding the resin portion and filling molten resin into the cavity to mold the resin portion; and
after the resin portion is molded, processing the rod material to mold the first connection portion or the second connection portion.

2. The manufacturing method for a unipolar terminal block according to claim 1,
wherein the first connection portion includes a bolt insertion hole, and
after the resin portion is molded, a cutting process is applied to the rod material to form the bolt insertion hole.

3. The manufacturing method for a unipolar terminal block according to claim 1,
wherein the unipolar terminal block includes a cylindrical collar that is held by the resin portion, and
in a state in which the rod material and the collar are set in the cavity, the molten resin is filled into the cavity to mold the resin portion.
